(19) United States
(12) Patent Application Publication
(10) Pub. No.: US 2014/0164645 A1
(43) Pub. Date: Jun. 12, 2014

(54) ROUTING TABLE MAINTENANCE

(71) Applicant: MICROSOFT CORPORATION, Redmond, WA (US)

(72) Inventor: Kumara Venkatesh Palani, Santa Clara, CA (US)

(73) Assignee: Microsoft Corporation, Redmond, WA (US)

(21) Appl. No.: 13/706,667

(22) Filed: Dec. 6, 2012

(51) Int. Cl. H04L 12/56

(52) U.S. Cl. CPC H04L 45/745
USPC 709/242

(57) ABSTRACT

Among other things, one or more techniques and/or systems are provided for maintain a routing table. The routing table may comprise a routing statement associated with a destination. The routing statement may comprise a domain identifier, such as a URL, for the destination and a gateway identifier, such as an IP address, for a gateway through which communication traffic to the destination may be routed. During routing of a request, an IP address for the destination may be dynamically resolved based upon the domain identifier within the routing statement. The IP address may be cached for a restricted period of time so that subsequent requests may utilize the cached IP address. Because the routing statement is based upon a domain identifier (e.g., as opposed to a hardcoded static IP address), the routing statement may remain valid even though an IP address of the destination may change.

### BACKGROUND

Today, many computing devices, such as personal computers, mobile devices, and/or tablets, are interconnected by one or more networks. In one example, a user may access work files stored on a company server by utilizing a virtual private network to access the company server. In another example, the user may access a social network website through a tablet device. In this way, a computing device may access various destinations based upon identifiers, such as destination IP addresses. A routing table may be used to hardcode static routes for destinations. For example, the routing table may comprise a static route mapping a destination IP address (e.g., an IP address of the social network website) to a gateway identifier (e.g., an IP address of a router through which a request to the social network website is to be routed). Unfortunately, the static route may become stale and broken if the destination IP address of the destination changes (e.g., a datacenter that hosts the social network website may reassign IP addresses for social network servers based upon various factors, such as loading balancing functionality). Thus, the static route may comprise an invalid destination IP address.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for maintaining a routing table are provided herein. That is, a computing device may be associated with a routing table used to route requests (e.g., data packets) to a destination. The routing table may comprise one or more routing statements that may be based upon domain identifier information. A routing statement may correspond to a pseudo static route mapping a domain identifier (e.g., a fully qualified domain name, such as a URL) to a gateway identifier (e.g., an IP address of a gateway, a virtual switch, a router, a next hop, etc.). It may be appreciated that the gateway identifier is not limited to an identifier of a gateway, but may correspond to an identifier of any component (e.g., router, a virtual component, a network enabled computing device, etc.) that may facilitate routing of data from the computing device to the destination. Unlike conventional routing tables, the routing statement may not be constrained to a hardcoded static IP address that may become stale and/or invalid over time.

In one example of maintaining the routing table, a routing statement is maintained within the routing table. The routing statement may comprise a domain identifier (e.g., a www.workemail.com URL) and a gateway identifier (e.g., an IP address 10.1.1.1 of a router (A)). A cache may be associated with the routing table. One or more cache entries mapping domain identifiers to IP addresses may be maintained within the cache. Because a destination may change an IP address over time (e.g., thus rendering an entry mapping a domain identifier of the destination to the IP address stale and/or invalid), a cache expiration may be associated with an entry. Upon expiration of the cache expiration, the entry may be removed from the cache and/or updated with new IP address information (e.g., provided by a domain name system (DNS) server).

A request may be received to access the destination associated with the domain identifier within the routing statement. For example, a user, through a work laptop, may initiate a request to retrieve email from a work email server located within a domain associated with a www.workemail.com URL. In one example of resolving an IP address for the domain identifier of the request, an entry mapping the domain identifier (e.g., www.workemail.com URL) to an IP address (e.g., 2.2.2.2) may be identified within the cache. The IP address may be resolved for the request to the work email server based upon the entry. In another example of resolving an IP address for the domain identifier of the request, a determination may be made that the cache does not comprise an entry associated with the domain identifier. The IP address may be resolved based upon a DNS server lookup (e.g., the DNS server may provide the IP address of 2.2.2.2 for the www.workemail.com URL). In this way, the IP address may be dynamically intersected with (e.g., bound to) the request to create an updated request. The updated request may be routed to a gateway associated with the gateway identifier (e.g., a data packet associated with the updated request may be routed to the router (A)) for further routing to the destination based upon the resolved IP address. Because a static domain identifier was specified within the routing statement, as opposed to a hardcoded static IP address, the request and/or subsequent requests to the destination may be routed based upon the first routing statement regardless of whether the IP address of the destination changes. It may be appreciated that although discussion is had herein with regard to a DNS and/or resolving an IP address using a DNS, the instant application including the scope of the claims is not intended to be limited to the same. For example, network basic input/output system (NetBIOS) and/or other technologies/techniques may be implemented for IP address resolution, for example.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a schematic diagram illustrating a conventional system for routing a data packet according to a hardcoded static IP address.

FIG. 2 is a schematic diagram illustrating a conventional system for routing a data packet according to a hardcoded static IP address.

FIG. 3 is a flow diagram illustrating an exemplary method of maintaining a routing table.

FIG. 4 is a component block diagram illustrating an exemplary system for maintaining a routing table.

FIG. 5 is a component block diagram illustrating an exemplary system for maintaining a routing table.

FIG. 6 is a component block diagram illustrating an exemplary system for maintaining a routing table.

FIG. 7 is a component block diagram illustrating an exemplary system for maintaining a routing table.

FIG. 8 is an example of removing an entry based upon a cache expiration expiring.

FIG. 9 is an illustration of an exemplary computing device-readable medium wherein processor-executable instructions configured to embody one or more of the provisions set forth herein may be comprised.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

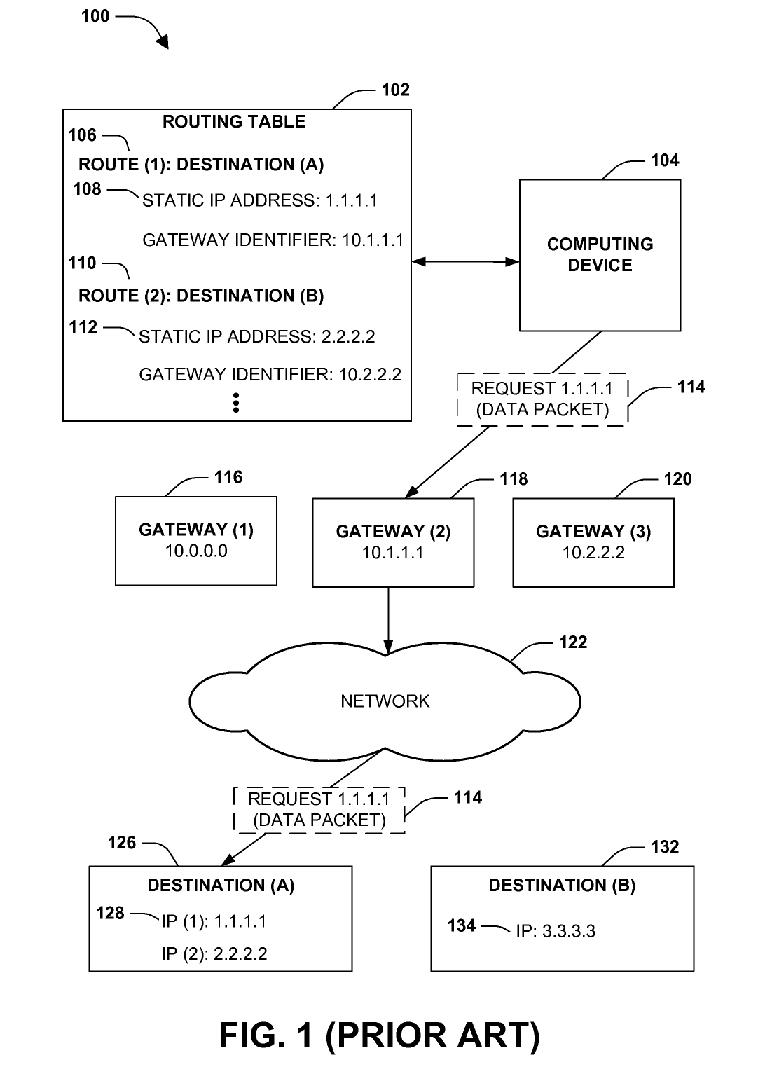

FIG. 1 is a schematic diagram illustrating a conventional system 100 for routing a data packet according to a hardcoded static IP address. The system 100 comprises a routing table 102 associated with a computing device 104. The routing table 102 comprises one or more routes, such as a first route 106 associated with a destination (A) 126 and a second route 110 associated with a destination (B) 132. The first route 106 comprises a hardcoded static IP address 108 for the destination (A) 126 (e.g., mapping to a first IP address 128 of the destination (A) 126) and a gateway identifier of a second gateway 118. The second route 110 comprises a hardcoded static IP address 112 for the destination (B) 132 (e.g., mapping to a first IP address 134 for the destination (B) 132) and a gateway identifier of a third gateway 120.

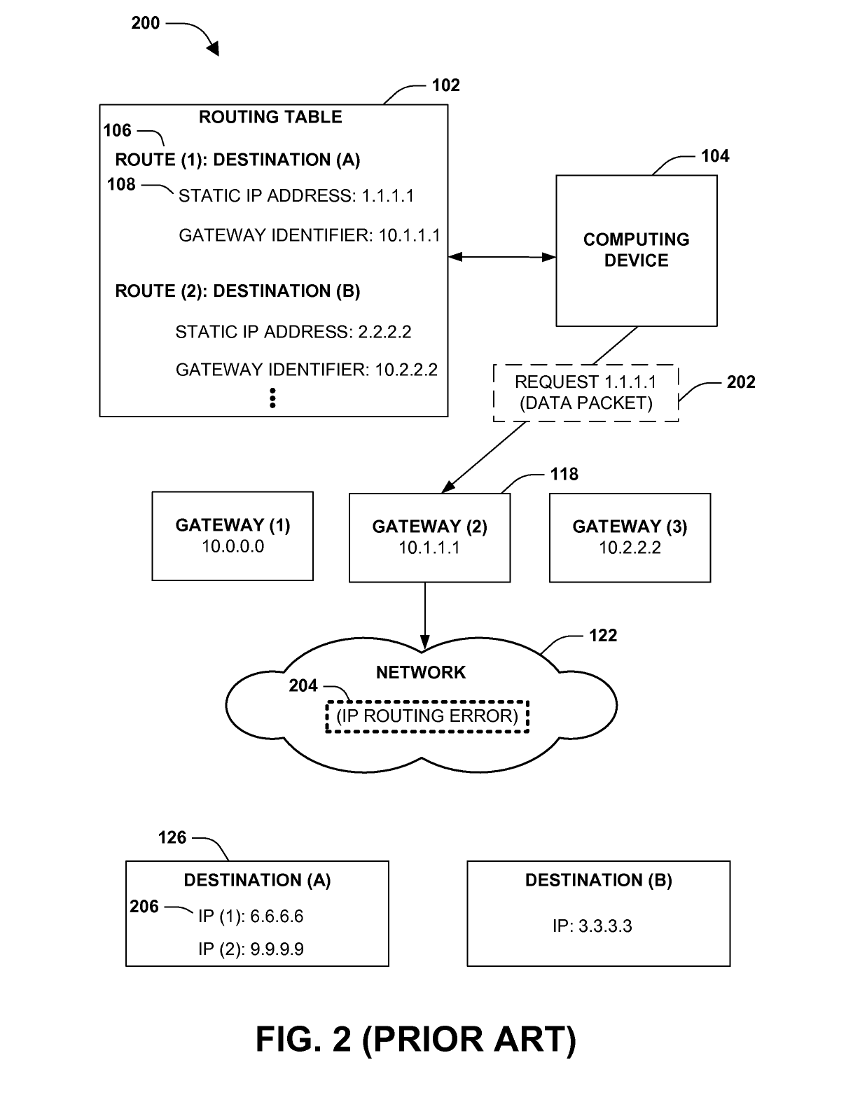

The computing device 104 is associated with a first gateway 116 (e.g., a default gateway), the second gateway 118, and the third gateway 120. The computing device 104 can receive and/or send data packets through such gateways to one or more destinations, such as the destination (A) 126 and/or the destination (B) 132 based upon the hardcoded static IP addresses 108 and/or 112. In one example of routing a data packet based upon a hardcoded static IP address within a routing table, the computing device 104 generates a request 114 (e.g., a data packet) to access destination (A) 126. The computing device 104 utilizes the routing table 102 to obtain the hardcoded static IP address 108 that is hardcoded for the destination (A) 126 and a gateway identifier for the second gateway 118 through which the request 114 is to be routed (e.g., a next hop). In this way, the request 114 is routed to the second gateway 118 based upon the gateway identifier, and is then routed through a network 122 to the destination (A) 126 based upon the hardcoded static IP address 108. Unfortunately, if the destination (A) 126 changes the first IP address 128 from 1.1.1.1 to a different IP address, such as 6.6.6.6, then the first route 106 will be stale and invalid, as illustrated in FIG. 2.

FIG. 2 is a schematic diagram illustrating a conventional system 200 for routing a data packet according to a hardcoded static IP address. It is to be appreciated that the conventional system 200 corresponds to the conventional system 100. For example, the convention system 200 comprises a routing table 102 comprising a first route 106 corresponding to a destination (A) 126. In particular, the first route 106 comprises a hardcoded static IP address 108 that previously corresponded to a first IP address of the destination (A) 126 (e.g., the first IP address 128 of 1.1.1.1 illustrated in FIG. 1). However, the destination (A) 126 changed the first IP address 128 of 1.1.1.1 to the first IP address 206 of 6.6.6.6. In this way, the hardcoded static IP address 108 of the first route 106 within the routing table 102 became stale and invalid. For example, a computing device 104 generates a request 202 (e.g., a data packet) to access the destination (A) 126. The computing device 104 utilizes the routing table 102 to obtain the hardcoded static IP address 108 that is hardcoded for the destination (A) 126 and a gateway identifier for the second gateway 118 through which the request 202 is to be routed (e.g., a next hop). In this way, the request 202 is routed to the second gateway 118 based upon the gateway identifier. However, routing of the request 202 results in a communication error (e.g., IP routing error 204) while being routed through a network 122 to the destination (A) 126 because the hardcoded static IP address 108 of 1.1.1.1 within the request 202 does not match the first IP address 206 of 6.6.6.6 and/or other IP addresses of the destination (A) 126.

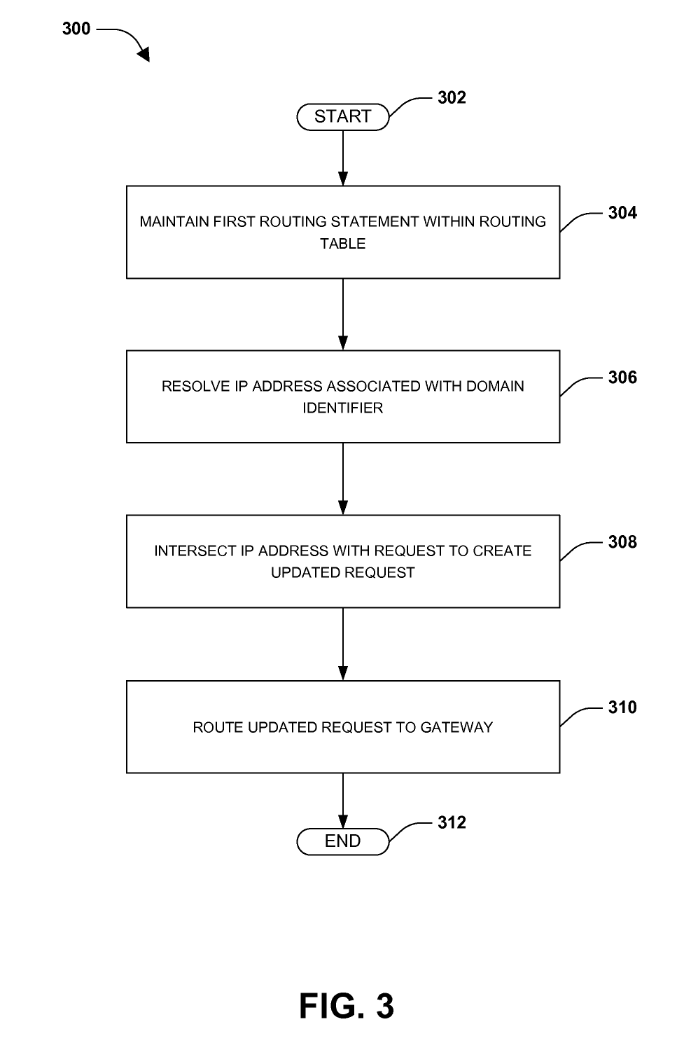

One embodiment of maintaining a routing table is illustrated by an exemplary method 300 of FIG. 3. At 302, the method starts. At 304, a first routing statement is maintained within a routing table. The first routing statement may comprise a domain identifier (e.g., a website URL, such as www.emailwebsite.com) and a gateway identifier (e.g., an IP address of a gateway, such as a router or virtual switch). The first routing statement may be used to route a request (e.g., a data packet) to a destination associated with the domain identifier by routing the request through a gateway associated with the gateway identifier. In one example, the routing table may comprise one or more routing statements, such as a second routing statement comprising a second domain identifier (e.g., a fully qualified domain name for a social network service) and a second gateway identifier (e.g., an IP address of a second gateway). The second domain identifier may be the same or different than the domain identifier of the first routing statement, and the second gateway identifier may be the same or different than the gateway identifier of the first routing statement.

In one example of routing a request based upon the first routing statement, a request to access the destination associated with the first routing statement may be received. At 306, an IP address associated with the domain identifier within the first routing statement may be resolved. In one example of resolving the IP address, a first entry may be identified within a cache. The first entry may comprise a mapping of the domain identifier to the IP address of the destination (e.g., the first entry may have been created based upon a prior domain name system (DNS) server lookup using the domain identifier to obtain a current IP address of the destination). In another example of resolving the IP address, responsive to the cache not comprising an entry corresponding to the domain identifier, a lookup request (e.g., a DNS server lookup) for the domain identifier may be sent to the DNS server. A response comprising the IP address for the destination may be received from the DNS server. In one example, an entry may be stored within the cache based upon the IP address received from the DNS server. The entry may comprise a mapping of the domain identifier to the IP address. Because the IP address for the destination may change over time, a cache expiration may be specified for the entry. The cache expiration may correspond to a time to live (TTL) value provided by the DNS server, a traffic flow associated with the domain identifier (e.g., the IP address may remain valid while (e.g., a certain volume of) communication traffic is flowing to/from the destination), cache configuration data (e.g., a default value of 1 hour), etc. If the DNS server provides additional IP addresses, then additional entries may be stored within the cache (e.g., a second entry comprising a second mapping of the domain identifier to a second IP address).

At 308, the IP address may be intersected with the request to create an updated request. For example, the IP address may be dynamically bound to the request en route during routing of the request. At 310, the updated request may be routed to a gateway associated with the gateway identifier (e.g., a router that connects a computing device that generated the request to a network through which the updated request may be routed). In this way, the updated request may be routed through a network to the destination.

In one example of implementing the routing table, the routing table may be associated with a virtual environment, such as a virtual environment within a datacenter. The routing table may be maintained within a virtual server of the datacenter, and the gateway identified by the gateway identifier may comprise a virtual switch hosted by the datacenter. In one example, encapsulation data may be used to encapsulate the updated request based upon the updated request corresponding to a hypervswitch. In this way, the gateway may be dynamically resolved based upon the encapsulation data and/or the gateway identifier (e.g., the encapsulation data may be used to modify the gateway identifier that may be otherwise statically defined within the routing table). At 312, the method ends.

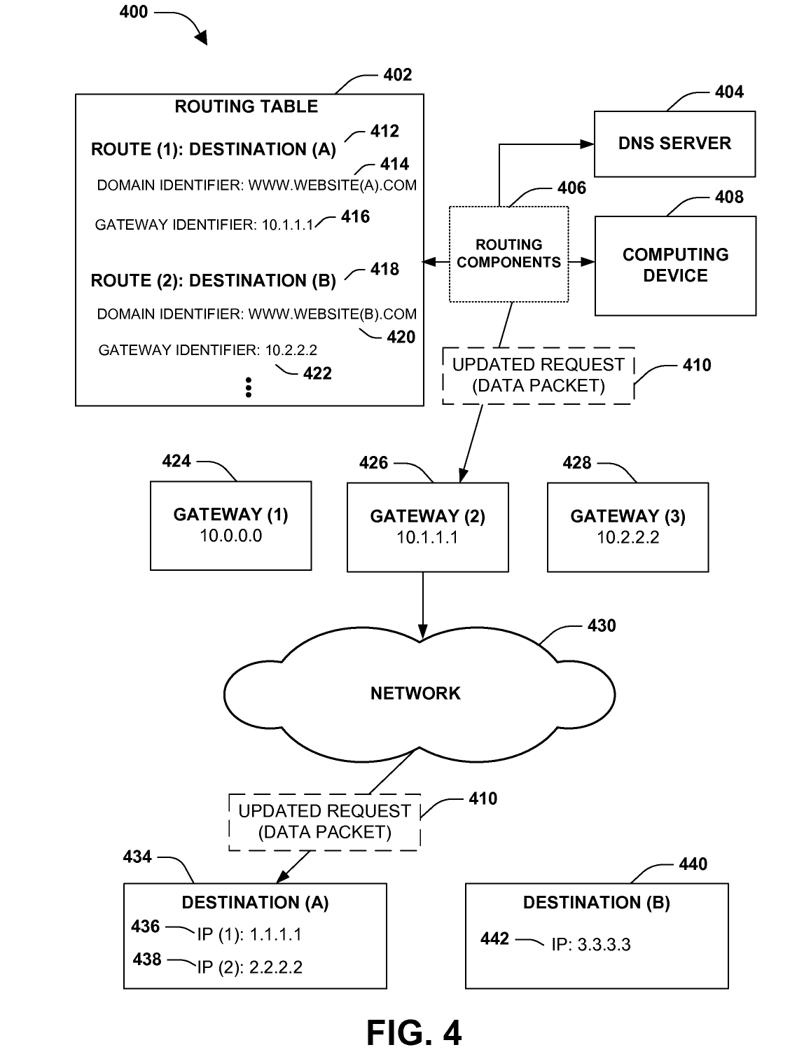

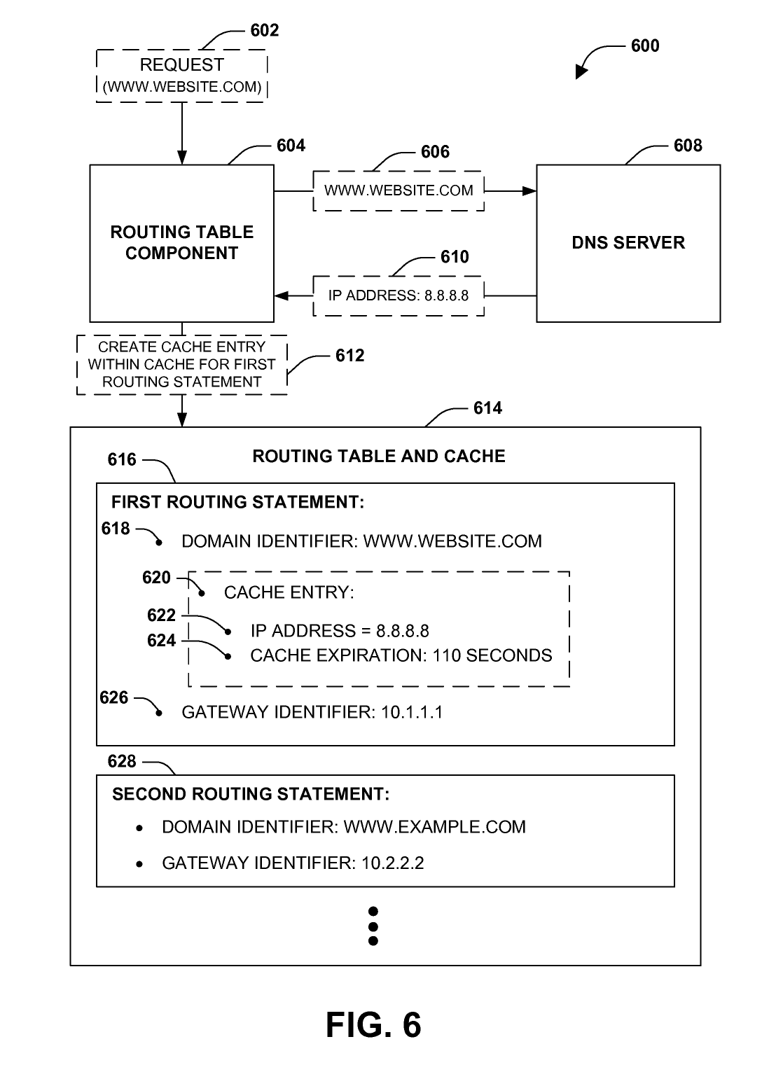

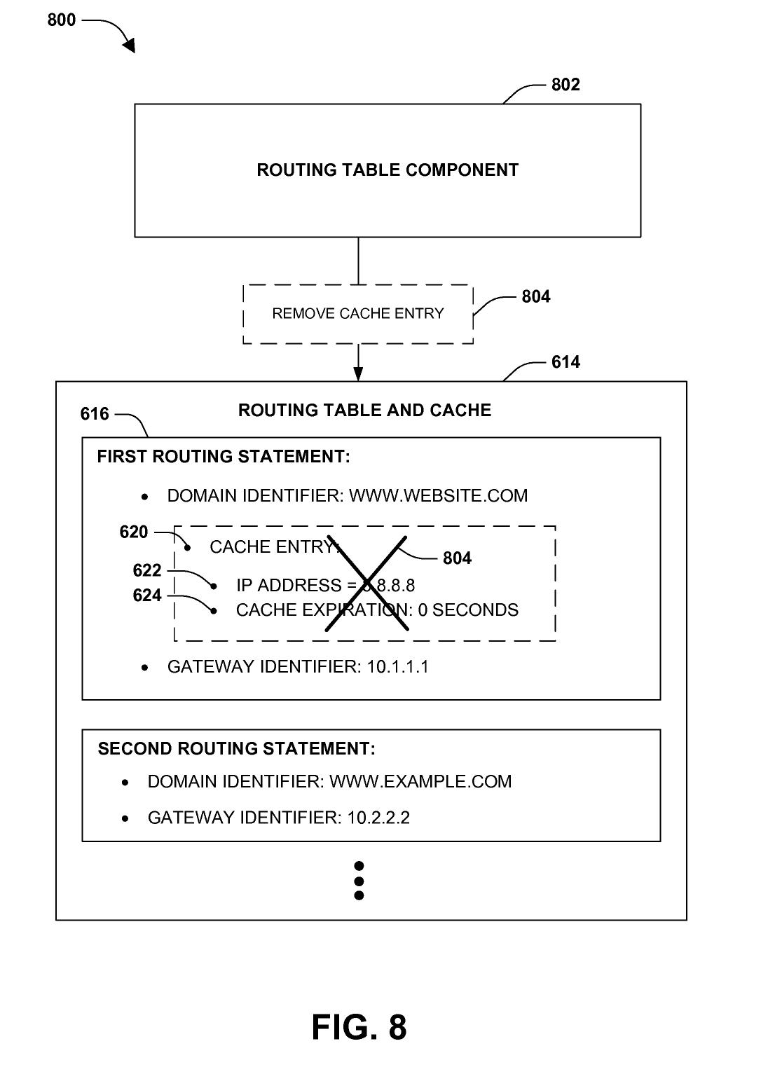

FIG. 4 illustrates an example of a system 400 configured for maintaining a routing table 402. The system 400 comprises a routing table component and/or a routing component (e.g., routing components 406). The routing table component may be configured to maintain one or more routing statements within the routing table 402. For example, the routing table component may maintain a first routing statement 412, a second routing statement 418, and/or other routing statements not illustrated. The first routing statement 412 may comprise a domain identifier 414 (e.g., a URL, such as www.website(A).com) and a gateway identifier 416 (e.g., an IP address of 10.1.1.1 for a router). The domain identifier 414 may identify a destination (A) 434, and the gateway identifier 416 may identify a second gateway 426 through which communication traffic between a computing device 408 and the destination (A) 434 is to be routed. The second routing statement 418 may comprise a domain identifier 420 (e.g., a URL, such as www.website(B).com) and a gateway identifier 422 (e.g., an IP address of 10.2.2.2 for a virtual switch). The domain identifier 420 may identify a destination (B) 440, and the gateway identifier 422 may identify a third gateway 428 through which communication traffic between the computing device 408 and the destination (B) 440 is to be routed. It may be appreciated that some embodiments of the routing table component maintaining the routing table 402 are illustrated in FIGS. 6 and 8.

The computing device 408 may comprise a network enabled device, such as a personal computer, a mobile device, a tablet device, and/or other devices that may communicate over a network 430. The computing device 408 may be configured to communicate over the network 430 by routing data packets (e.g., data packets associated with a request to a destination) through a first gateway 424 (e.g., a next hop device), the second gateway 426 (e.g., a router), and/or the third gateway 428 (e.g., a virtual switch). The destination (A) 434, the destination (B) 440, and/or other destinations not illustrated may be accessible to the computing device 408 through the network 430. For example, a request may be routed to the destination (A) 434 based upon a first IP address 436 of 1.1.1.1 and/or a second IP address 438 of 2.2.2.2, and a request may be routed to the destination (B) 440 based upon a first IP address 442 of 3.3.3.3. The routing components 406 and/or the computing device 408 may be associated with a DNS server 404 that may be configured to resolve IP addresses based upon domain identifiers, such as ULRs and/or fully qualified domain names (FQDN), for example.

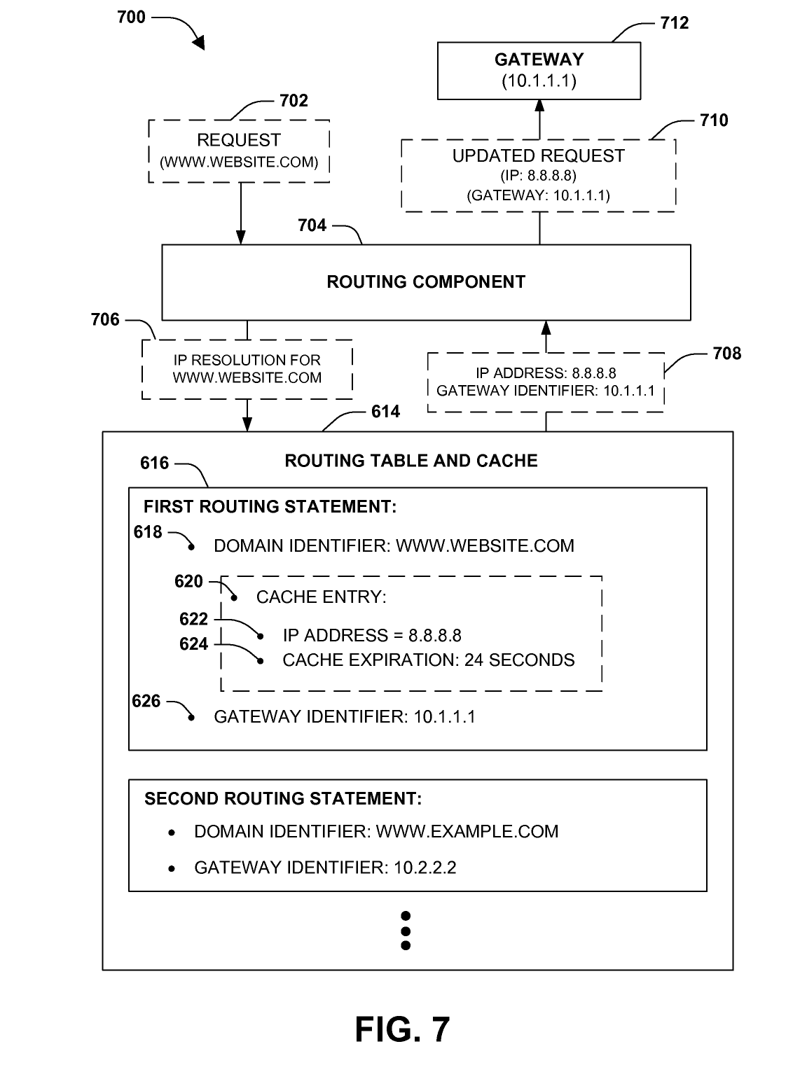

In one example of routing a request from the computing device 408 to the destination (A) 434, the computing device 408 may generate a request (e.g., comprising one or more data packets that are to be sent to the destination (A) 434). The routing component may be configured to receive the request that is to be routed to the destination (A) 434. The routing component may determine that the request to the destination (A) 434 corresponds to the first routing statement 412 associated with the destination (A) 434. The routing component may obtain the domain identifier 414 and the gateway identifier 416 from the first routing statement 412. In one example, the routing component may resolve an IP address for the destination (A) 434 based upon an entry, within a cache, that comprises a mapping of the domain identifier 414 to the IP address. It may be appreciated that some embodiments of utilizing a cache to resolve an IP address are illustrated in FIG. 7. In another example, the routing component may resolve the IP address for the destination (A) 434 based upon a DNS lookup to the DNS server 404. The DNS server 404 may provide the IP address for the destination (A) 434 based upon the domain identifier 414. In this way, the routing component may resolve the IP address associated with the domain identifier 414.

The routing component may be configured to intersect the IP address with the request to create an updated request 410. For example, the IP address may be dynamically bound to the request en route during routing of the request (e.g., after the computing device 408 generated the request). The updated request 410 may be routed through the network 430 to the destination (A) 434 based upon the IP address that was resolved from the domain identifier 414 that was statically specified within the first routing statement 412. In this way, the first routing statement 412 may comprise a pseudo static route, such that the domain identifier 414 and the gateway identifier 416 may be statically defined, but an IP address for the domain identifier 414 may be dynamically resolved and/or bound to a request en route. Thus, when the destination (A) 434 changes IP address, the first routing statement 412 may still be valid (e.g., because the domain identifier 414 is used instead of an IP address).

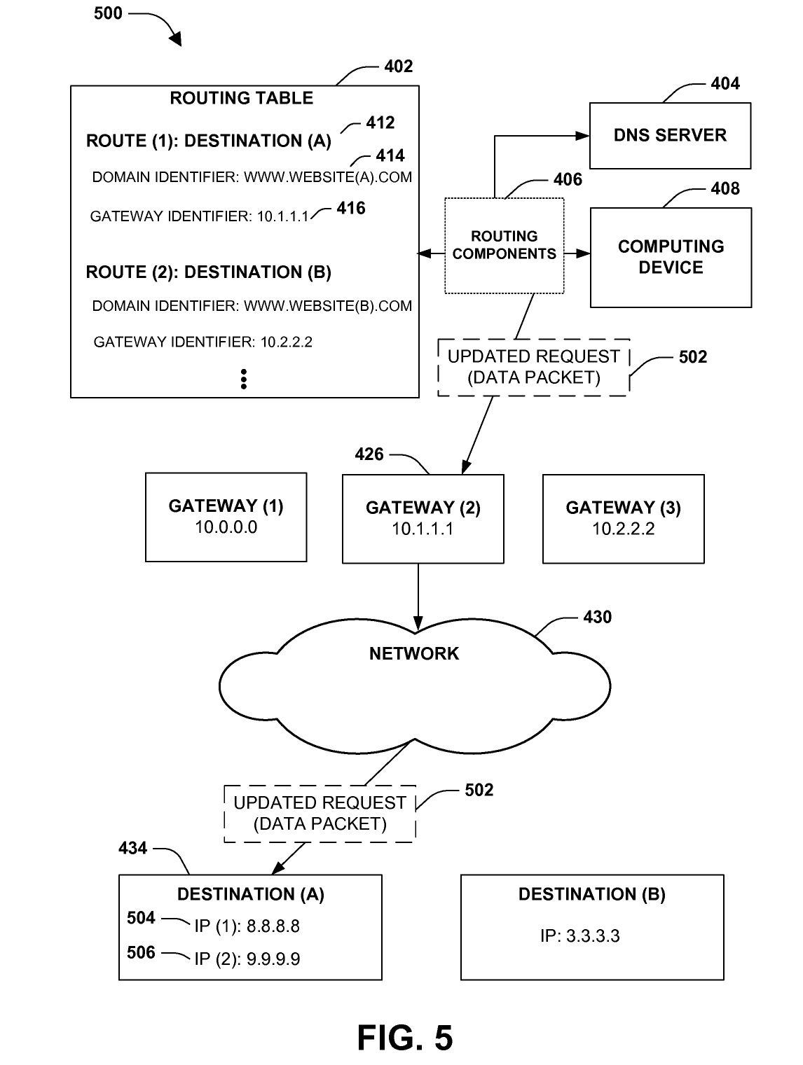

FIG. 5 illustrates an example of a system 500 configured for maintaining a routing table 402. It may be appreciated that in one example, the system 500 may correspond to the system 400 of FIG. 4. For example, the system 500 may comprise a routing table component and/or a routing component (e.g., routing components 406) configured to facilitate routing of communication traffic between a computing device 408 and one or more destinations (e.g., destination (A) 434) over a network 430. The routing table 402 may comprise a first routing statement 412 associated with the destination (A) 434. The first routing statement 412 may comprise a domain identifier 414 and a gateway identifier 416, which may be used to route a request (e.g., one or more data packets) between the computing device 408 and the destination (A) 434.

In one example of routing a request from the computing device 408 to the destination (A) 434, the computing device 408 may generate a request (e.g., comprising one or more data packets that are to be sent to the destination (A) 434). The routing component may be configured to receive the request to access the destination (A) 434. The routing component may determine that the request to the destination (A) 434 corresponds to the first routing statement 412 associated with the destination (A) 434. The routing component may obtain the domain identifier 414 and the gateway identifier 416 from the first routing statement 412. It may be appreciated that in one example, the domain identifier 414 is substantially similar to the domain identifier 414 of FIG. 4, however, the destination (A) 434 may have changed the first IP address 436 of FIG. 4 from 1.1.1.1 to a first IP address 504 of 8.8.8.8 and may have changed the second IP address 438 of FIG. 4 from 2.2.2.2 to a second IP address 506 of 9.9.9.9. As provided herein, a request from the computing device 408 may be successfully routed to the destination (A) 434, having the updated IP addresses, utilizing the first routing statement 412 because the domain identifier 414 within the first routing statement 412 may have remained substantially similar for the destination (A) 434. In this way, an updated IP address (e.g., 8.8.8.8) may be resolved by the routing component from the DNS server 404 based upon the domain identifier 414. The updated IP address may be intersected with the request to create the updated request 502, which may be routed through a second gateway 426 corresponding to the gateway identifier 416. The updated request 502 may be routed through the network 430 to the destination (A) 434. Because the first routing statement 412 comprises the domain identifier 414 (e.g., as opposed to a hardcoded static IP address), the first routing statement 412 may not become stale and/or invalid when the destination (A) 434 changes IP addresses.

FIG. 6 illustrates an example of a system 600 configured for maintaining a routing table 614. The system 600 may comprise a routing table component 604. The routing table component 604 may be configured to maintain one or more routing statements within the routing table 614. For example, the routing table 614 may comprise a first routing statement 616 associated with a first destination and a second routing statement 628 associated with a second destination. The first routing statement 616 may comprise a domain identifier 618 that may identify the first destination (e.g., a URL, such as www.website.com) and a gateway identifier 626 through which a request from a computing device to the first destination may be routed (e.g., an IP address of a router behind a firewall may be specified for the first destination due to security concerns). An entry 620 for the first routing statement 616 may be maintained within a cache associated with the routing table 614. The entry 620 may be used to dynamically resolve an IP address for the first destination based upon the domain identifier 618.

In one example of populating the entry 620, a request 602 to access the first destination (e.g., www.website.com) may be generated by a computing device. The routing table component 604 may determine that the request 602 corresponds to the first routing statement 616 for the first destination. The routing table component 604 may obtain the domain identifier 618 (e.g., from the request 602 and/or from the first routing statement 616). Because the cache associated with the routing table 614 may not comprise an entry (e.g., entry 620) mapping the domain identifier 618 to an IP address (e.g., when the request 602 is being processed by the routing table component 604), the routing table component 604 may send 606 the domain identifier 618 to a DNS server 608. The DNS server 608 may return 610 an IP address 622 resolved for the domain identifier 618. The routing table component 604 may create 612 the entry 620 for the first routing statement 616. The entry 620 may comprise the IP address 622 for the first destination (e.g., a current IP address for the first destination may be 8.8.8.8). In one example, the entry 620 may comprise a cache expiration 624 because the IP address 622 for the first destination may change over time, thus rendering the IP address 622 stale and/or invalid. For example, the cache expiration 624 may specify that the entry 620 is to be removed from the cache after 110 seconds (e.g., corresponding to a time to live (TTL) value provided by the DNS server 608 for the IP address 622). It may be appreciated that one example of removing an entry from a cache is illustrated in FIG. 8. In this way, the IP address 622 may be cached for a restricted period of time so that requests to the first destination may utilize the IP address 622 within the cache.

FIG. 7 illustrates an example of a system 700 for routing a request based upon a routing statement within a routing table 614. It may be appreciated that in one example, the routing table 614 may correspond to the routing table 614 of FIG. 6. For example, the routing table 614 may comprise a first routing statement 616. The first routing statement 616 comprises a domain identifier 618 and a gateway identifier 626. An entry 620, associated with a first destination identified by the domain identifier 618, may have been populated within a cache (e.g., created 612 by a routing table component 604 of FIG. 6). The entry 620 may comprise an IP address 622 for the first destination, and may be available until a cache expiration 624 expires (e.g., 24 seconds).

In one example of routing a request 702 to a destination, the system 700 may comprise a routing component 704. The routing component 704 may be configured to receive the request 702 that is to be routed to the first destination. The routing component 704 may determine that the first destination is associated with the first routing statement 616. For example, the first destination may be associated with the domain identifier 618 (e.g., www.website.com) comprised within the first routing statement 616. The routing component 704 may be configured to resolve 706 the IP address 622 for the destination based upon the domain identifier 618. For example, the routing component 704 may determine that the entry 620 maps the domain identifier 618 to the IP address 622 of the destination. The routing component 704 may obtain 708 the IP address 622 and the gateway identifier 626 associated with the first routing statement 616. The routing component 704 may intersect the IP address 622 with the request 702 to create an updated request 710. The updated request 710 may be routed to a gateway 712 associated with the gateway identifier 626. In this way, the updated request 710 may be routed through the gateway 712 to the first destination.

FIG. 8 illustrates an example of removing 804 an entry based upon a cache expiration expiring. A routing table component 802 may be configured to maintain a routing table 614 and/or a cache associated with the routing table 614. The routing table 614 may comprise a first routing statement 616 associated with a first destination. For example, the first routing statement may comprise a domain identifier that identifies the first destination. An entry 620 within a cache may be associated with the first routing statement 616. For example, the entry 620 may comprise an IP address 622 for the first destination. The entry 620 may comprise a cache expiration 624. The entry 620 may be valid until the cache expiration 624 expires because the first destination may change IP addresses over time. For example, upon expiration of the cache expiration 624, the routing table component 802 may remove 804 the entry 620. In this way, the routing table component 802 may maintain the routing table 614.

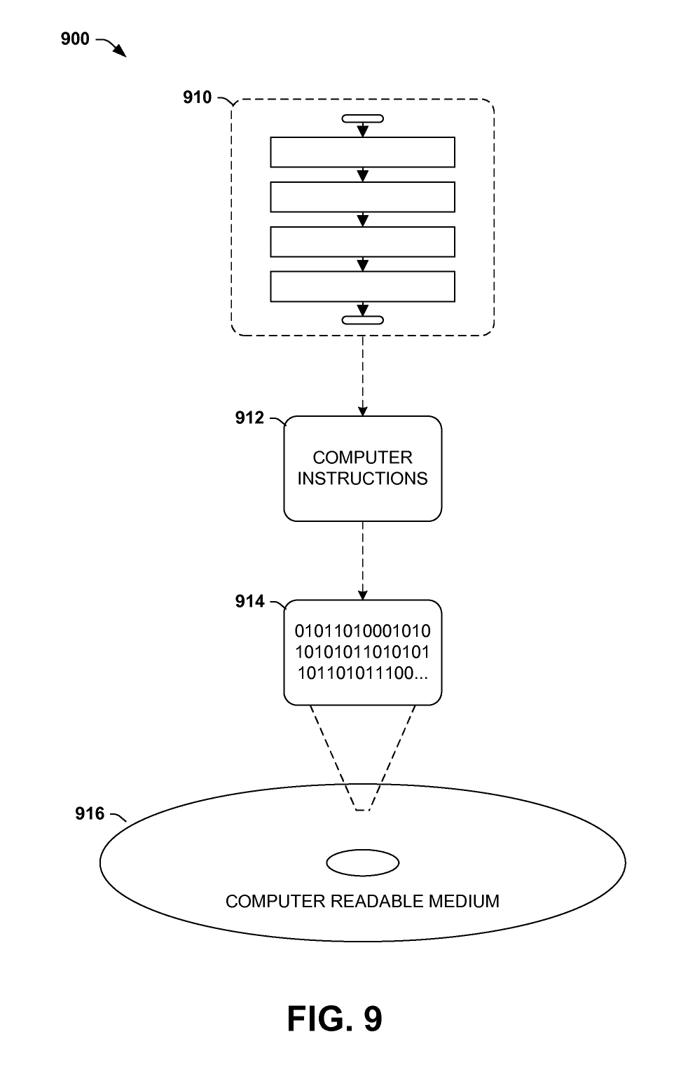

Still another embodiment involves a computing device-readable medium comprising processor-executable instructions configured to implement one or more of the techniques presented herein. An exemplary computing device-readable medium that may be devised in these ways is illustrated in FIG. 9, wherein the implementation 900 comprises a computing device-readable medium 916 (e.g., a CD-R, DVD-R, or a platter of a hard disk drive), on which is encoded computing device-readable data 914. This computing device-readable data 914 in turn comprises a set of computing device instructions 912 configured to operate according to one or more of the principles set forth herein. In one such embodiment 900, the processor-executable computing device instructions 912 may be configured to perform a method 910, such as at least some of the exemplary method 300 of FIG. 3, for example. In another such embodiment, the processor-executable instructions 912 may be configured to implement a system, such as at least some of the exemplary system 400 of FIG. 4, at least some of the exemplary system 500 of FIG. 5, at least some of the exemplary system 600 of FIG. 6, and/or at least some of the exemplary system 700 of FIG. 7, for example. Many such computing device-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computing device-related entity, either hardware, a combination of hardware and software, software, or software in execution. For example, a component may be, but is not limited to being, a process running on a processor, a processor, an object, an executable, a thread of execution, a program, and/or a computing device. By way of illustration, both an application running on a controller and the controller can be a component. One or more components may reside within a process and/or thread of execution and a component may be localized on one computing device and/or distributed between two or more computing devices.

Furthermore, the claimed subject matter may be implemented as a method, apparatus, or article of manufacture using standard programming and/or engineering techniques to produce software, firmware, hardware, or any combination thereof to control a computing device to implement the disclosed subject matter. The term “article of manufacture” as used herein is intended to encompass a computing device program accessible from any computing device-readable device, carrier, or media. Of course, those skilled in the art will recognize many modifications may be made to this configuration without departing from the scope or spirit of the claimed subject matter.

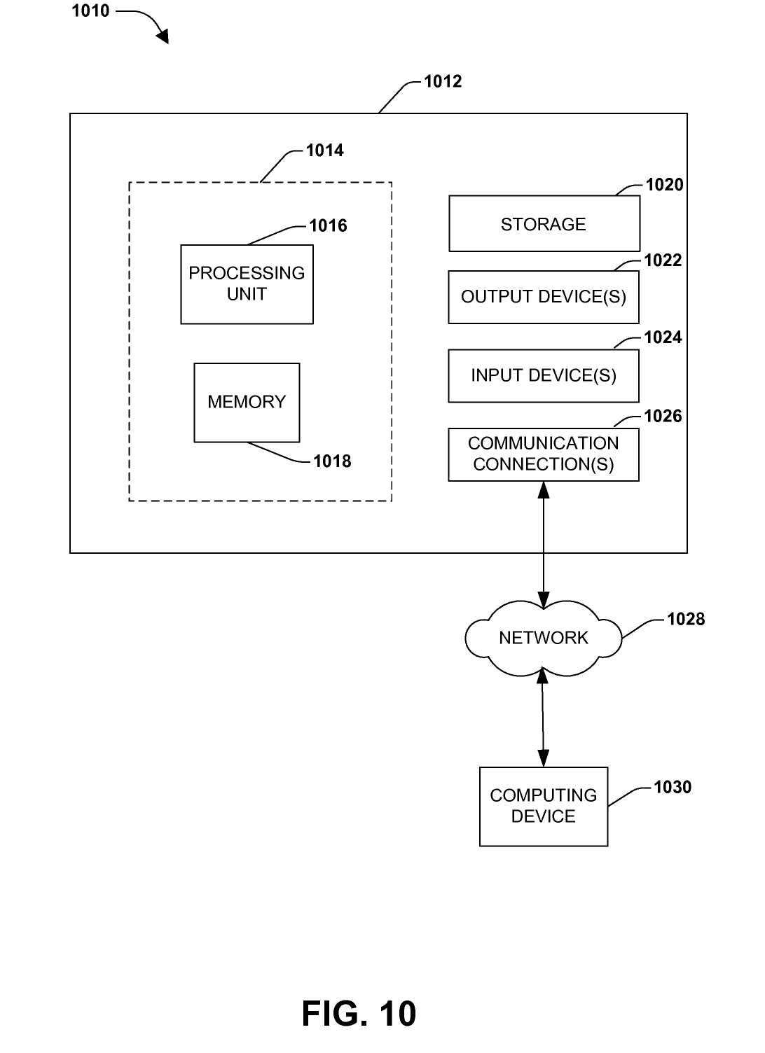

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computing devices, server computing devices, hand-held or laptop devices, mobile devices (such as mobile phones, Personal Digital Assistants (PDAs), media players, and the like), multiprocessor systems, consumer electronics, mini computing devices, mainframe computing devices, distributed computing environments that include any of the above systems or devices, and the like.

Although not required, embodiments are described in the general context of “computing device readable instructions” being executed by one or more computing devices. Computing device readable instructions may be distributed via computing device readable media (discussed below). Computing device readable instructions may be implemented as program modules, such as functions, objects, Application Programming Interfaces (APIs), data structures, and the like, that perform particular tasks or implement particular abstract data types. Typically, the functionality of the computing device readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computing device readable instructions to implement one or more embodiments provided herein may be in storage 1020. Storage 1020 may also store other computing device readable instructions to implement an operating system, an application program, and the like. Computing device readable instructions may be loaded in memory 1018 for execution by processing unit 1016, for example.

The term “computing device readable media” as used herein includes computing device storage media. Computing device storage media includes volatile and nonvolatile, removable and non-removable media implemented in any method or technology for storage of information such as computing device readable instructions or other data. Memory 1018 and storage 1020 are examples of computing device storage media. Computing device storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computing device storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computing device readable media” may include communication media. Communication media typically embodies computing device readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computing device readable instructions may be distributed across a network. For example, a computing device 1030 accessible via a network 1028 may store computing device readable instructions to implement one or more embodiments provided herein. Computing device 1012 may access computing device 1030 and download a part or all of the computing device readable instructions for execution. Alternatively, computing device 1012 may download pieces of the computing device readable instructions, as needed, or some instructions may be executed at computing device 1012 and some at computing device 1030.

Various operations of embodiments are provided herein. In one embodiment, one or more of the operations described may constitute computing device readable instructions stored on one or more computing device readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for maintaining a routing table, comprising:
maintaining a first routing statement within a routing table, the first routing statement comprising a domain identifier and a gateway identifier; and
responsive to receiving a request to access a destination associated with the domain identifier:
resolving an IP address associated with the domain identifier;
intersecting the IP address with the request to create an updated request; and
routing the updated request to a gateway associated with the gateway identifier.

2. The method of claim 1, the resolving an IP address comprising:
identifying a first entry within a cache, the first entry comprising a mapping of the domain identifier to the IP address.

3. The method of claim 1, the resolving an IP address comprising:
sending a lookup request for the domain identifier to a domain name system (DNS) server; and
receiving a response comprising the IP address from the DNS server.

4. The method of claim 3, comprising:
storing a first entry within a cache, the first entry comprising a mapping of the domain identifier to the IP address.

5. The method of claim 4, the response comprising a time to live (TTL) value, and the storing comprising specifying a cache expiration for the first entry based upon the TTL value.

6. The method of claim 4, comprising:
specifying a cache expiration for the first entry based upon at least one of:
cache configuration data; or
traffic flow associated with the domain identifier.

7. The method of claim 4, the response from the DNS server comprising a second IP address, and the method comprising:
storing a second entry within the cache, the second entry comprising a second mapping of the domain identifier to the second IP address.

8. The method of claim 1, the intersecting comprising:
dynamically binding the IP address to the request en route during routing of the request.

9. The method of claim 1, comprising:
maintaining the routing table within a virtual server of a datacenter.

10. The method of claim 9, the gateway comprising a virtual switch hosted by the datacenter.

11. The method of claim 1, the intersecting comprising:
encapsulating the updated request with encapsulation data based upon the request corresponding to a hypervswitch.

12. The method of claim 11, the encapsulating comprising:
dynamically resolving the gateway based upon the gateway identifier and the encapsulation data.

13. The method of claim 1, comprising:
maintaining a second routing statement within the routing table, the second routing statement comprising a second domain identifier and a second gateway identifier, the second domain identifier different than the domain identifier and the second gateway identifier different than the gateway identifier.

14. A system for maintaining a routing table, comprising:
a routing table component configured to:
maintain a first routing statement within a routing table, the first routing statement comprising a domain identifier and a gateway identifier; and
a routing component configured to:
responsive to receiving a request to access a destination associated with the domain identifier:
resolve an IP address associated with the domain identifier;
intersect the IP address with the request to create an updated request; and
route the updated request to a gateway associated with the gateway identifier.

15. The system of claim 14, the routing component configured to:
identify a first entry within a cache, the first entry comprising a mapping of the domain identifier to the IP address.

16. The system of claim 14, the routing component configured to:
send a lookup request for the domain identifier to a domain name system (DNS) server; and
receive a response comprising the IP address from the DNS server.

17. The system of claim 16, the routing table component configured to:
store a first entry within a cache, the first entry comprising a mapping of the domain identifier to the IP address.

18. The system of claim 15, the routing table component configured to:
specify a cache expiration for the first entry based upon at least one of:
a time to live (TTL) value specified by a domain name server;
cache configuration data; or
traffic flow associated with the domain identifier.

19. The system of claim 18, the routing table component configured to:
remove the first entry from the cache based upon expiration of the cache expiration.

20. A computer readable medium comprising instructions which when executed at least in part via a processing unit perform a method for maintaining a routing table, comprising:
maintaining a routing statement within a routing table, the routing statement comprising a domain identifier and a gateway identifier; and
responsive to receiving a request to access a destination associated with the domain identifier:
responsive to determining that a cache comprises an entry comprising a mapping of the domain identifier to an IP address, resolving the IP address for the request based upon the entry;
responsive to determining that the cache does not comprise the entry, resolving the IP address for the request based upon a domain name system (DNS) server lookup;
intersecting the IP address with the request to create an updated request; and
routing the updated request to a gateway associated with the gateway identifier.
